(19) United States
(12) Patent Application Publication
(10) Pub. No.: US 2004/0069863 A1
(43) Pub. Date: Apr. 15, 2004

(54) Fuel injection valve

(76) Inventor: Patrick Mattes, Stuttgart (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/031,713

(22) PCT Filed: Apr. 24, 2001
(86) PCT No.: PCT/DE01/01540

(30) Foreign Application Priority Data
May 23, 2000 (DE) 100 25 497.7

(51) Int. Cl. F02M 47/02

(52) U.S. Cl. 239/88; 239/96; 239/585.1; 239/585.5

(57) ABSTRACT

In a fuel injection valve for internal combustion engines, having a valve housing, having an axially movable valve member for opening and closing an injection opening of the injection valve, and having a part, which acts in the closing direction of the valve member, which is guided with its end remote from the injection opening in a bore of a first valve piece inserted into the valve housing and with this end, encloses a control pressure chamber in the first valve piece, which control pressure chamber can be connected to a high-pressure fuel connection via an inlet conduit, which is provided with at least one inlet throttle, and can be connected to a low-pressure fuel connection via an outlet conduit, which has an outlet throttle and can be closed by a movable control valve member, where the injection process can be controlled by means of the fuel pressure in the control pressure chamber, the proposal is made that at least the section of the inlet conduit provided with the inlet throttle be disposed in a second valve piece inserted into the valve housing, which second valve piece is connected to an opening embodied in the first valve piece in such a way that the section of the inlet conduit of the second valve piece provided with the inlet throttle feeds into the control pressure chamber of the first valve piece.

### PRIOR ART

The invention relates to a fuel injection valve with the features of the preamble to claim 1.

A fuel injection valve of this kind, which is also referred to as an injector, has been disclosed for example by DE 196 50 865 A1 and is used in fuel injection systems that are equipped with a high-pressure fuel reservoir. In the known fuel injection valve, fuel pressure prevailing in a control pressure chamber loads a valve needle in the closing direction by means of a valve piston. The control pressure chamber is situated in a valve piece inserted into the valve housing, and this chamber is connected to a high-pressure fuel connection by means of an inlet conduit provided with an inlet throttle and is connected to a low-pressure fuel connection by means of an outlet conduit provided with an outlet throttle. The outlet throttle and inlet throttle are both situated in the same valve piece that is inserted into the valve housing. A valve member of a control valve, which for example has a magnetic or piezoelectric actuator as a driving mechanism, can open and close the outlet conduit and control the fuel pressure in the control chamber for the individual actuating operations of the valve needle. The opening speed of the valve needle when the outlet conduit is open is determined by the flow difference between the inlet throttle and outlet throttle and thus finally by the fixed ratio of sizes of the inlet and outlet throttles. In the known fuel injection valve, it is disadvantageous that both the inlet throttle and the outlet throttle must be produced with very high precision in the same component. If the geometric dimensions of one of the throttles do not lie within the required precision range, the entire valve piece must be remade. Since the inlet conduit and the outlet conduit feed into the control pressure chamber approximately perpendicular to each other, the precise production of the inlet throttle and outlet throttle in the same valve piece is also expensive and the number of manufacturing rejects is correspondingly high. In the known fuel injection valve, a section of the inlet conduit disposed in the valve body, from which a pressure bore leading to the injection opening branches, feeds into an annular chamber encompassing the valve piece, which annular chamber communicates with the inlet throttle. This is disadvantageous in that the bore let into the valve body for the inlet conduit produces a critical bore error in the vicinity of the pressure bore, which can lead to functional impairments when there are high pressures in the inlet conduit.

### ADVANTAGES OF THE INVENTION

The fuel injection valve according to the invention, with the characterizing features of claim 1, avoids the above-described disadvantages. This is achieved by means of a second valve piece, which is produced independently of the first valve piece, contains the section of the inlet conduit provided with the inlet throttle, and is connected to an opening disposed on the first valve piece in such a way that the section of the inlet conduit provided with the inlet throttle and belonging to the second valve piece feeds into the control pressure chamber of the first valve piece. Since the inlet throttle and the outlet throttle are let into two separate components, these can be produced with the required precision in a significantly simpler manner and independently of each other and the number of manufacturing rejects is reduced. In a subsequent adjustment of the injector, when deviations from the predetermined through flow between the inlet throttle and outlet throttle are detected, the second valve piece with the inlet throttle can be simply replaced, without having to remove the first valve piece that contains the control pressure chamber. The fuel injection valve does not have to be completely removed for this, thus permitting a simple coordination of the fuel flow between the inlet and outlet throttles by matching and replacing the second valve piece. The replaceable inlet throttle thus permits a simple subsequent adjustment of the injection valve when there are quantity deviations in the test lab.

Modifications and advantageous embodiments of the invention are permitted by the features contained in the dependent claims.

It is particularly advantageous if the opening embodied in the first valve piece branches from the control pressure chamber in a direction radial to the valve member and the second valve piece is inserted into a receiving bore of the valve housing extending outward coaxial to the opening of the first valve piece and, with an end section into which the inlet conduit feeds, is inserted into the opening of the first valve piece. As a result, the second valve piece in the receiving bore of the valve housing can be replaced in a manner that is very easy to install.

Various embodiments of the second valve piece are possible which include a seal that seals the connection between the first valve piece and the second valve piece.

In an advantageous exemplary embodiment, the inner wall of the opening embodied in the first valve piece constitutes a preferably conical seat face for a sealing edge embodied on the outer wall of the second valve piece.

The connection fitting that is provided anyway for the high-pressure fuel connection of the inlet valve can advantageously also be used as a bracing element, which at least indirectly braces the second valve piece in relation to the first valve piece. In an exemplary embodiment, a spring element is clamped between the connection fitting and the second valve piece, which presses the sealing edge of the second valve piece against a conical seat face of the valve piece.

Advantageously, a bore error can be avoided if a pressure bore, which is disposed in the valve housing and supplies the injection opening with the fuel to be injected, feeds into the receiving bore containing the second valve piece, preferably in the vicinity of the spring element.

In a second exemplary embodiment, the second valve piece is embodied of one piece with the connection fitting for the high-pressure fuel connection and is provided with a seat seal. A graduation encompassing the inlet conduit is provided on the outer wall of the second valve piece, which produces an annular support face for a sealing ring that is pressed with its side oriented away from the support face against the first valve piece. In this instance, the high-pressure connection is produced by means of a bore, which feeds into the inlet conduit between the inlet throttle and the inlet of the inlet conduit remote from the control pressure chamber and connects the inlet conduit to a pressure bore disposed in the valve housing, which pressure bore supplies the injection opening with the fuel to be injected.

### DRAWINGS

Exemplary embodiments of the invention are shown in the drawings and will be explained in detail in the subsequent description.

FIG. 1a shows a section through the upper part of a fuel injection valve known from the prior art that has a magnetic actuator,

FIG. 1b shows a section through the lower part of the known fuel injection valve from FIG. 1a,

FIG. 2 shows a partial section from a first exemplary embodiment of a fuel injection valve according to the invention, and

FIG. 3 shows a partial section from a second exemplary embodiment of a fuel injection valve according to the invention.

### DESCRIPTION OF THE EXEMPLARY EMBODIMENTS

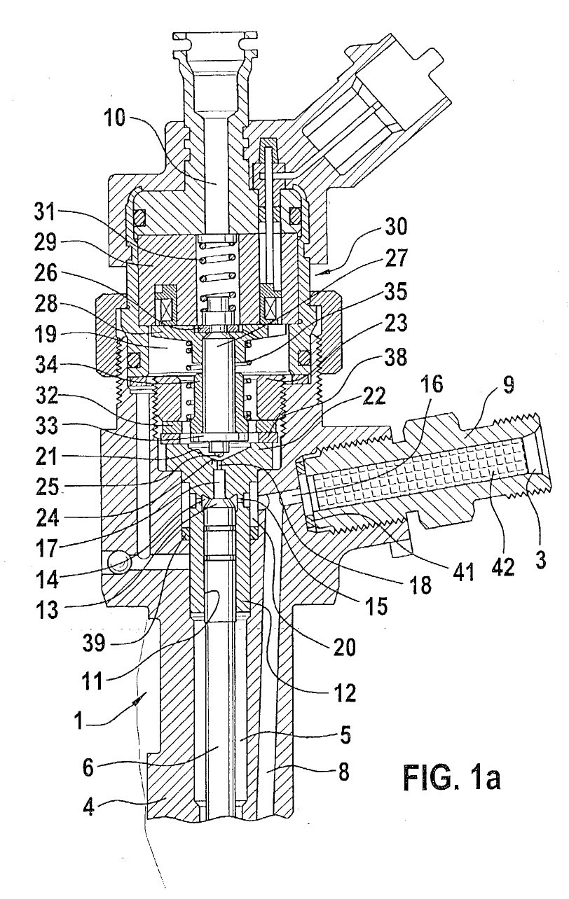

FIGS. 1a and 1b show a section through an electrically controlled fuel injection valve according to the prior art, for example of the kind disclosed by DE 196 50 865 A1. A fuel injection valve of this kind is intended for use in a fuel injection system equipped with a high-pressure fuel reservoir, which is continuously supplied with high-pressure fuel by a high-pressure feed pump and from which this fuel can be supplied to the internal combustion engine at injection pressure by means of individual electrically controlled injection valves. The fuel injection valve 1 shown in FIGS. 1a and 1b has a valve housing 4 with a longitudinal bore 5, which contains a piston-like part 6 that is embodied for example as a push rod, which at its one end, via a thrust-carrying piece 67, acts on a valve needle 60 disposed in a nozzle body 65, which valve needle 60 closes at least one injection opening 7 in the nozzle body 65 by means of the closing force of a nozzle spring 63 and the closing force of the part 6. The nozzle body is connected to the valve body by means of a spiral pin 66 and a nozzle-tensioning nut 64. In a known manner, the valve needle 60 is provided with a pressure shoulder 68, which is disposed in a pressure chamber 61 of the nozzle body 65. The pressure chamber 61 is supplied with high-pressure fuel via a pressure bore 8. With an opening stroke motion of the part 6 the valve needle 60 is lifted up counter to the closing force of the spring 63 by the high fuel pressure in the pressure chamber 61 continuously acting on the pressure shoulder 68. The injection of fuel into the combustion chamber of the internal combustion engine then occurs by means of the injection opening 7 that is then connected to the pressure chamber 61. The lowering of the part 6 presses the valve needle 60 into the valve seat 62 of the injection valve in the closing direction of the spring force of the spring 63 and brings the injection process to an end.

As can best be seen in FIG. 1a, at its end disposed opposite from the valve needle 60, the part 6 is guided in a cylinder bore 11, which is let into a valve piece 12 that is inserted into the valve housing 4. The end face 13 of the part 6 encloses a control pressure chamber 14 in the cylinder bore 11, which chamber is connected to a high-pressure fuel connection 3 via an inlet conduit 16. The inlet conduit 16 is essentially comprised of three parts. A bore, which passes radially through the wall of the valve piece 12 and whose inner walls along a part of their length constitute an inlet throttle 15, continuously communicates with an annular chamber 20 that encompasses the valve piece on its circumference, which annular chamber in turn continuously communicates, via a fuel filter 42 inserted into the inlet conduit, with the high-pressure fuel connection 3 of a connection fitting 9 that can be screwed into the valve housing 4. The annular chamber 20 is sealed in relation to the longitudinal bore 5 by means of a sealing ring 39. The control pressure chamber 14 is subjected to the high fuel pressure prevailing in the high-pressure fuel reservoir via the inlet conduit 16. Coaxial to the part 6, a bore extending in the valve piece 12 branches off from the control pressure chamber 14, which bore constitutes an outlet conduit 17 provided with an outlet throttle 18, which outlet conduit feeds into a relief chamber 19 that communicates with a low-pressure fuel connection 10, which in turn is connected to a fuel return, not shown in detail, of the injection valve 1. The outlet conduit 17 exits from the valve piece 12 in the vicinity of a conically countersunk part 21 of the outer end of the valve piece 12. The valve piece 12 here is clamped to the valve housing 4 in a flange region 22 by means of a screw element 23.

A valve seat 24 is embodied in the conical part 21 and cooperates with a control valve member 25 of a solenoid valve 30 that controls the injection valve. The control valve member 25 is coupled to a two-part armature in the form of an armature bolt 27 and an armature disk 28, which armature cooperates with an electromagnet 29 of the solenoid valve 30. Through the action of its inertial mass counter to the initial stress of a restoring spring 35, the armature plate is supported on the armature bolt in a dynamically mobile fashion and in the idle position, is pressed by this restoring spring against a stop ring 26 on the armature bolt. The restoring spring 35 is supported affixed to the housing by means of a flange 32 of a slide piece 34, which guides the armature bolt and is tightly clamped in the valve housing along with this flange, between the valve piece 12 and the screw element 23. The armature bolt, the armature disk, and the control valve member 25 connected to the armature bolt, are continuously acted on in the closing direction by a closing spring 31 supported affixed to the housing so that normally, the control valve member 25 rests in the closed position against the valve seat 24. When electromagnet is excited, it attracts the armature plate 28 and thereby opens the outlet conduit 17 to the relief chamber 19. Between the control valve member 25 and the armature plate 28, there is an annular shoulder 33 on the armature bolt 27, which shoulder rests against the flange 32 when electromagnet is excited and thus limits the opening stroke of the control valve member 25. In order to adjust the opening stroke, an adjusting screw 38 is inserted between the flange 32 and the valve piece 12. The opening and closing of the valve needle is controlled in the following manner by the solenoid valve. In the closed position of the control valve member 25, the control pressure chamber 14 is closed off from the relief side 19 so that the pressure that also prevails in the high-pressure fuel reservoir is built up very rapidly in this control pressure chamber by means of the inlet conduit 16 provided with the inlet throttle 15. By means of the surface area of the end face 13, the pressure in the control pressure chamber 14 exerts a closing force on the part 6 and the valve needle 60 connected to it, which is greater than the forces acting on the other side in the opening direction as a result of the prevailing high pressure. If the control pressure chamber 14 is opened to the relief side 19 through the opening of the solenoid valve, the pressure in the small volume of the control pressure chamber 14 decreases rapidly since this chamber is decoupled from the high-pressure side by the inlet throttle 15. As a result, the force acting on the valve needle in the opening direction resulting from the high fuel pressure prevailing against the valve needle predominates so that this valve needle moves upward and as a result, the at least one injection opening 7 is opened for injection. However, if the solenoid valve 30 closes the outlet conduit 17, the pressure in the control pressure chamber 14 can nevertheless be quickly built up again by means of the replenishing flow of fuel from the inlet conduit 16 so that the original closing force is generated and the valve needle of the fuel injection valve closes. Naturally, in lieu of a magnetic actuator cooperating with the control valve member 25, a piezoelectric actuator, a combination of a piezoelectric actuator and magnetic actuator, or a different actuator can also be used.

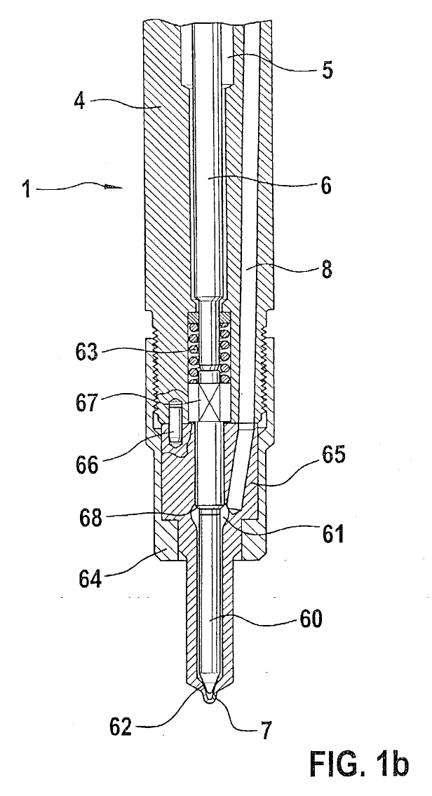

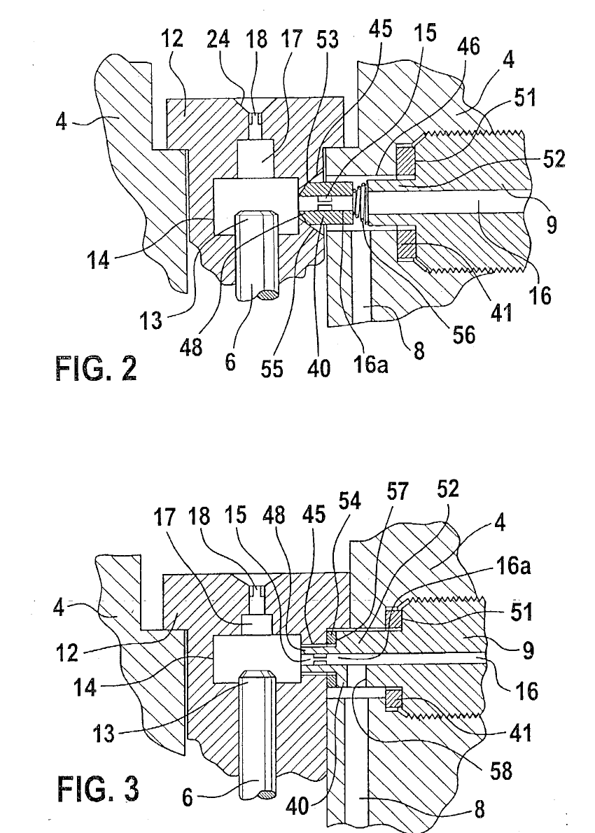

FIGS. 2 and 3 show two exemplary embodiments for a fuel injection valve according to the invention. The partial depictions in FIGS. 2 and 3 are limited to the parts that differ from FIGS. 1a and 1b. Parts that are the same have been provided with the same reference numerals

In the first exemplary embodiment in FIG. 2, a second valve piece 40 is embodied as an essentially cylindrical insert piece, which is inserted into a receiving bore 46 of the valve housing 4. The outer diameter of the cylindrical second valve piece 40 is slightly smaller than the inner diameter of the receiving bore 46. The end 48 of the second valve piece 40 oriented toward the control pressure chamber 14 has a circumferential sealing edge 53, which cooperates with a seat face 55 embodied on the first valve piece 12, as will be further described below. In addition, the second valve piece 40 has an axial bore, which constitutes a section 16a of the inlet conduit 16. A diametrically narrowed section of the inner wall of the inlet conduit section 16a embodied in the second valve piece 40 constitutes the inlet throttle 15. The inlet throttle is produced in a known manner in the second valve piece 40 which, like the first valve piece 12, can be made of metal, for example. In principle, the first and second valve pieces can also be made of different materials. The first valve piece 12 differs from the valve piece 12 shown in FIG. 1a in that instead of the section of the inlet conduit 16 that has the inlet throttle 15, an opening 45 is provided in the first valve piece, which opening extends laterally out from the control pressure chamber 14, radial to the cylinder bore 11. The inner wall 55 of the opening 45 constitutes a conical seat face for the second valve piece 40, which increases in diameter toward the outside, starting from the control pressure chamber 14. The second valve piece 40 is inserted with the end section 48 into the receiving bore 46 in such a way that the sealing edge 53 rests against the conical sealing face 55 and the end section 48 of the second valve piece 40 with the outlet opening of the inlet conduit 16 is oriented toward the control pressure chamber 14. On its end oriented toward the second valve piece 12, the connection fitting 9 has a stepped annular surface 51 from which a cylindrical projection 52 of the connection fitting 9 protrudes toward the second valve piece 40. A spring element 56, for example a spring washer or a helical compression spring, is disposed between the second valve piece 40 and the cylindrical projection 52. The connection fitting 9 is screwed into a threaded bore of the valve housing 4 and, with the protrusion 52 engaging in the receiving bore 46, presses the spring element 56 against the second valve piece 40, which is thereby pressed with the sealing edge 53 into the conical seat face 55. A sealing ring 41, which is slid over the protrusion 52 and rests against the annular surface 51, is simultaneously pressed against the valve housing 4 and seals the valve housing in relation to the connection fitting. A pressure bore 8, which is disposed in the valve housing 4 and supplies the pressure chamber 61 with fuel, feeds into the receiving bore 46 in the vicinity of the spring element 56. The high-pressure fuel travels from the high-pressure fuel reservoir via the fuel filter, first into the part of the inlet conduit 16 situated in the connection fitting 9, and from there on the one hand, travels through the interstices of the spring element 56 into the receiving bore 46 and the pressure bore 8 and on the other hand, travels through the section 16a of the second valve piece 40 and the inlet throttle 15, into the control pressure chamber 14. By contrast with the exemplary embodiment shown here, it is also possible to eliminate the spring element 56 and to place the second valve piece 40 directly against the first valve piece 12 with initial stress by means of the screw-connected connection fitting 9. The protrusion 52 of the connection fitting 9 can then have a lateral bore feeding radially into the inlet conduit 16 in order to connect the pressure bore 8 to the inlet conduit. It is also possible to embody the region of the first valve piece 12 surrounding the opening 45 and the end face 48 of the second valve piece 40 as flat and to press the second valve piece 40 with a sealing ring against the flat part of the outer wall of the first valve piece 12. In this case, the second valve piece 40 does not engage in the opening 45 of the first valve piece.

FIG. 3 shows another exemplary embodiment. In this exemplary embodiment, the second valve piece 40 is made of metal and is of one piece with the connection fitting 9. In principle, this exemplary embodiment results in the fact that the cylindrical protrusion 52 of the connection fitting 9 from FIG. 2 is lengthened somewhat and has an additional graduation which constitutes an annular support face 57 for an additional sealing ring 54, for example a Viton seal. An additional cylindrical protrusion projects from the support face 57 and with its end face 48, engages in the opening 45 of the first valve piece 12. When the connection fitting 9 is screwed into the threaded bore of the valve housing 4, the sealing ring 54 is pressed against the outer wall of the first valve piece 12 consequently sealing the control pressure chamber 14. A lateral bore 58, which connects the inlet conduit with the pressure bore 8 disposed in the valve housing 4, feeds into the inlet conduit 16 between the inlet throttle 15 and the inlet 3 of the inlet conduit 16 remote from the control pressure chamber 14. Preferably, this lateral bore 58 is let into the connection fitting 3 approximately coaxial to the pressure bore 8.

1. A fuel injection valve (1) for internal combustion engines, having a valve housing (4), having an axially movable valve member (60) for opening and closing an injection opening (7) of the injection valve, and having a part (6), which acts in the closing direction of the valve member (60), which is guided with its end (13) remote from the injection opening (7) in a bore (11) of a first valve piece (12) inserted into the valve housing (4) and with this end (13), encloses a control pressure chamber (14) in the first valve piece (12), which control pressure chamber (14) can be connected to a high-pressure fuel connection (3) via an inlet conduit (16), which is provided with at least one inlet throttle (15), and can be connected to a low-pressure fuel connection (10) via an outlet conduit (17), which has an outlet throttle and can be closed by a movable control valve member (25), where the injection process can be controlled by means of the fuel pressure in the control pressure chamber (14), which pressure is controlled by the control valve member (25), characterized in that at least the section (16a) of the inlet conduit (16) provided with the inlet throttle (15) is disposed in a second valve piece (40) inserted into the valve housing (4), which second valve piece (40) is connected to an opening (45) embodied in the first valve piece (12) in such a way that the section (16a) of the inlet conduit (16) of the second valve piece (40) provided with the inlet throttle (15) feeds into the control pressure chamber (14) of the first valve piece (12).

2. The fuel injection valve according to claim 1, characterized in that the opening (45) embodied in the first valve piece (12) branches off from the control pressure chamber (14), radial to the axis of the bore (11) and in that the second valve piece (40) is inserted into a receiving bore (46) of the valve housing (4) extending outward, coaxial to the opening (45) of the first valve piece (12) and is inserted with an end section (48), into which the inlet conduit (16) feeds, into the opening (45) of the first valve piece (12).

3. The fuel injection valve according to claim 1 or 2, characterized in that a seal (53, 54) is provided, which seals the connection between the first valve piece (12) and the second valve piece (40).

4. The fuel injection valve according to claim 3, characterized in that a connection fitting (9) of the injection valve (1), which fitting has the high-pressure fuel connection (3) and can be attached to the valve housing (4), constitutes a bracing part, which braces the second valve piece (40) against the first valve piece (12), at least indirectly.

5. The fuel injection valve according to claim 4, characterized in that the inner wall (55) of the opening (45) embodied in the first valve piece (12) constitutes a seat face for a sealing face (53) embodied on the outer wall of the second valve piece (40).

6. The fuel injection valve according to claim 5, characterized in that the seat face (55) is embodied in a conical form.

7. The fuel injection valve according to claim 5, characterized in that a spring element (56) is clamped between the connection fitting (9) and the second valve piece (40), which presses the sealing edge (53) of the second valve piece (40) against the seat face (55).

8. The fuel injection valve according to claim 7, characterized in that a pressure bore (8), which is disposed in the valve housing (4) and supplies the injection opening (7) with the fuel to be injected, feeds into the receiving bore (46) containing the second valve piece (40), preferably in the vicinity of the spring element (56).

9. The fuel injection valve according to claim 4, characterized in that the second valve piece (40) is embodied of one piece with the connection fitting (9), which has the high-pressure fuel connection (3) and can be attached to the valve housing (4).

10. The fuel injection valve according to claim 9, characterized in that a graduation encompassing the inlet conduit (16) is provided on the outer wall of the second valve piece (40); which forms an annular support face (57) for a sealing ring (54) used to produce a seal, which is pressed with its side remote from the support face (57) against the first valve piece (12) and seals the opening (45) of the control pressure chamber (14).

11. The fuel injection valve according to claim 9 or 10, characterized in that between the inlet throttle 15) and the inlet (3) of the inlet conduit (16) remote from the control pressure chamber (14), a bore (58) feeds into the inlet conduit (16) and connects the inlet conduit to a pressure bore (8) disposed in the valve housing (4), which pressure bore (8) supplies the injection opening (7) with the fuel to be injected.

12. The fuel injection valve according to claim 11, characterized in that the bore (48) feeding into the inlet conduit (16) is let into the connection fitting (3) approximately coaxial to the pressure bore (8).
